(19) United States
(12) Patent Application Publication
(10) Pub. No.: US 2023/0198262 A1
(43) Pub. Date: Jun. 22, 2023

(54) DISTRIBUTED ENERGY SYSTEMS AND METHODS THEREOF

(71) Applicant: ZOLA ELECTRIC LABS INC., San Francisco, CA (US)

(72) Inventors: Claudio VERGARA, Amsterdam (NL); William Joseph LENIHAN, Hillsborough, CA (US); Masautso Nau NGOSI, Emeryville, CA (US)

(21) Appl. No.: 17/555,334

(22) Filed: Dec. 17, 2021

(51) Int. Cl. H02J 3/38; H02J 3/46

(52) U.S. Cl. CPC H02J 3/381; H02J 3/466; G06Q 50/06

(57) ABSTRACT

Various embodiments provide methods and systems for the deployment of distributed energy systems. In an embodiment, a method, performed by a microgrid controller of a microgrid, includes receiving information indicating that a failure has occurred in at least one external grid connected to the microgrid. In response to receiving the information, the method further includes transmitting operational parameters to one or more energy resources to regulate power injected into the microgrid when the microgrid is importing power from the at least one external grid.

### TECHNICAL FIELD

The present disclosure relates generally to distributed energy systems and, more particularly to, a platform that enables the deployment and installation of distributed energy systems (DES).

### BACKGROUND

To participate in today's world, electricity is one of the foremost necessities. It acts as a limiting factor in communities, and as such, an investment in electricity is also an investment in education, employment, healthcare, infrastructure, and more. Nonetheless, the spatial dispersion of customers, lack of financial resources, and institutional constraints in several developing countries have resulted in a chronic lack of coverage of the public grid, motivating the development of the so-called off-grid solutions that take advantage of photovoltaic generation and battery energy storage systems.

The expansion of access to reliable power in emerging countries currently relies on a combination of expansions of conventional electric grids and off-grid technologies such as solar home systems and microgrids. At the same time, distributed energy systems (DES) are gaining ground in highly developed economies, partly driven by the need to decarbonize electric power systems (EPS) and partly by the important cost reductions in solar photovoltaic (PV) generation and battery energy storage systems (BESS).

While it is technically feasible to build independent solar home systems (SHS) for each customer, two main drivers offer benefits from interconnecting several buildings. First, load profiles from multiple customers are complementary. This means that the amount of investment needed to provide reliable power to a group of customers jointly is significantly lower than the sum of the investment needed to supply each one individually. Second, the presence of economies of scale in electricity supply systems favors building larger ones. As a consequence, microgrids are the most efficient choice for communities where the cost of wiring the buildings together does not outweigh the benefits from these two drivers. In addition to this, an area that is electrified based on multiple microgrids exchanging electricity resources exhibits higher robustness and power quality, and is more resilient to major disturbances like earthquakes and hurricanes compared to traditional architectures which rely solely on the mainstream electric grid.

In areas, where people currently do not have access to electricity, microgrids are often risky endeavors due to the high levels of uncertainty associated with their development. Most of this risk is challenging (or impossible) for individual developers to control, be it future consumption of electricity, exchange rates, regulatory changes, or the potential arrival of the electric grid. This risk is only compounded by the large initial capital investments required to get a microgrid up and running; if the endeavor fails, a large sum of money is lost and a community is left without power. Current technologies are not well-equipped to mitigate the uncertainties of microgrid development.

Therefore, there is a need for improvement in the microgrid development and installation of microgrids.

### SUMMARY

Various embodiments of the present disclosure provide methods and systems for the deployment of distributed energy systems.

In an embodiment, a method is disclosed. The method includes receiving, by a microgrid controller of a microgrid, information indicating that a failure has occurred in at least one external grid connected to the microgrid. In response to receiving the information indicating the failure, the method further includes transmitting, by the microgrid controller, operational parameters to one or more energy resources to regulate power injected into the microgrid when the microgrid is importing power from the at least one external grid.

In another embodiment, a microgrid controller is disclosed. The microgrid controller includes a processor and a communication interface. The memory is configured to store instructions which, when executed by the processor, cause the microgrid controller to perform one or more operations as described below. The microgrid controller is configured to receive information indicating that a failure has occurred in at least one external grid connected to the microgrid from one or more interfaces in the microgrid; in response to the reception of the information indicating the failure, transmit operational parameters to one or more energy resources to regulate power injected into the microgrid when the microgrid is importing power from the at least one external grid.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device or a tool and instrumentalities disclosed herein. Moreover, those in the art will understand that the drawings are not to scale. Wherever possible, like elements have been indicated by identical numbers:

FIG. 1 is an illustration of an environment related to at least some example embodiments of the present disclosure;

FIG. 2 is a block diagram of a microgrid controller configured to control the microgrid, in accordance with an embodiment of the invention;

FIG. 3 is a block diagram of a synchronous interface configured to interconnect two electric power systems, in accordance with an embodiment of the invention;

FIG. 4 is a graph plotted between a state of charge (SOC) of a DER and a fraction of intertie set points, in accordance with an embodiment of the invention;

FIG. 5 depicts graphs plotted between SOC on the horizontal axis and meter power limit, frequency, and power import set point on the vertical axis, in accordance with an embodiment of the invention;

FIG. 6A depicts a phasor diagram of an imbalanced three-phase system, in accordance with an embodiment of the invention;

FIG. 6B is a block diagram of a balancing transformer connected with DERs, in accordance with an embodiment of the invention;

FIG. 6C depicts a phasor diagram of a balanced three-phase system, in accordance with an embodiment of the invention;

FIG. 7 is a sequence flow diagram depicting a process flow for managing distributed energy systems in real-time, in accordance with an embodiment of the invention;

FIG. 8 is a sequence flow diagram depicting a process flow for managing energy scarcity in a microgrid, in accordance with an embodiment of the invention;

FIG. 9 is a flow chart depicting a method performed by a microgrid controller, in accordance with an embodiment of the invention;

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The terms “consumer”, “customer”, “user”, “load”, and “houses” have been used interchangeably throughout the description, and they refer to any person, entity, or group that uses the power supply provided by the power supply companies.

The terms “electrical power supply system”, “distribution network”, “power distribution network”, “grid”, “microgrid”, and “power grid”, have been used interchangeably throughout the description, and they refer to an electrical network of one or more components deployed to supply, transfer and use electric power. The majority of the electrical power supply system(s) uses three-phase alternating current (AC) power for the large scale power transmission and distribution. Further, most of the customer locations (e.g., home) are generally provided with single-phase power supply, and the three-phase power supply is typically used in commercial/industrial situations and large homes.

### Overview

Various embodiments of the present disclosure provide methods and systems in a platform that enables the deployment and installation of distributed energy systems. In one embodiment, the system includes a microgrid controller that controls one or more network elements in a microgrid. The network elements include distributed energy resources (DERs), dynamic meters, balancing transformer, and synchronous interfaces. A synchronous interface connects the microgrid with another neighboring grid. If a failure is detected in the other neighboring grid, the synchronous interface disconnects the failed neighboring grid. If the microgrid was importing power from the other neighboring grid at the time of failure, the microgrid controller instructs the DERs to regulate the power injected into the microgrid. In one embodiment, the DERs increase the power injected into the microgrid in order to maintain nominal power and frequency in the microgrid. When the other neighboring grid recovers from the failure, the synchronous interface reconnects the other neighboring grid when synchronization conditions are met. The synchronization conditions indicate that the voltage, phase, and frequency of the two grids should be equal within predefined limits.

In another embodiment, the microgrid controller determines that the state of charge of batteries in the DERs is low. When the state of charge of the batteries is low, the DERs tend to withdraw power from the microgrid, thus leading to a drop in the frequency of the microgrid. The microgrid controller transmits parameters of the frequency versus limit function to the dynamic meters. The dynamic meters automatically disconnect users when consumption exceeds the limit as a function of the measured frequency.

Although process steps, method steps, or the like in the disclosure may be described in sequential order, such processes and methods may be configured to work in alternate orders. In other words, any sequence or order of steps that may be described in this patent application does not, in and of itself, indicate a requirement that the steps need to be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention (s), and does not imply that the illustrated process is preferred.

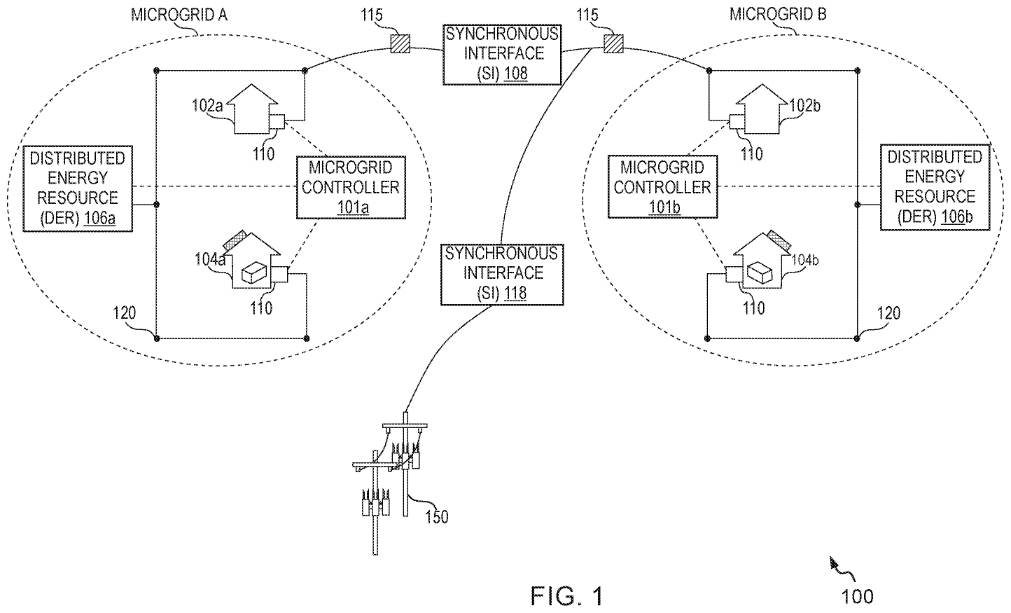

Various embodiments of methods and systems for deployment of microgrids are further described with reference to FIG. 1 to FIG. 9.

FIG. 1 is an example representation of an environment 100 related to at least some example embodiments of the present disclosure. The environment 100 includes microgrid A, microgrid B, and public power grid 150. Each microgrid includes at least one of distributed energy resources (DERs) 106a and 106b, synchronous interfaces 108 and 118, microgrid controllers 101a and 101b, consumers 102a, 102b, 104a, and 104b, balancing transformers 115, dynamic meters 110, and distribution poles 120. The houses 102a and 102b will not have access to electricity when the distribution network is not energized. The houses 104a and 104b are also equipped with DERs respectively. The DERs are electrically coupled to a microgrid A and a microgrid B respectively, such that energy or power, generated by the DERs 106a and 106b and DERs installed at houses 104a and 104b, is provided to the microgrids A and B. The DERs installed at houses 104a and 104b are exemplarily depicted to be solar panels and/or photovoltaic (PV) panels. Additionally or alternatively, the DERs installed at houses 104a and 104b may include but are not limited to, wind source, biogas source, low-power hydroelectricity, and the like.

The microgrids A and B are interconnected between themselves, where microgrid A has a distribution network also connected to a public power grid 150 using electricity transmission lines. The synchronous interface 108 is configured to connect the microgrids A and B. The synchronous interface 118 is configured to connect the microgrids A and B with the public power grid 150. On each microgrid, several loads 102, 104 and distributed energy resources (DERs) 106a and 106b are connected to a low-voltage distribution network, which can be made of single-phase and/or three-phase distribution lines. A DER can also be installed within the premises of a customer of either microgrid (e.g., houses 104a and 104b), therefore DERs in the microgrids being a behind the meter DER, or supply-side DERs, which are directly connected to the distribution network. The main difference between both the modes, is that users 104a, 104b will continue to have access to electricity when the distribution network is not energized, while consumers 102a, 102b, who rely exclusively on supply-side DERs will not have access to electricity when the distribution network is not energized.

The microgrid controllers 101a and 101b control all the components in their respective microgrids A and B. In order to connect microgrid A to microgrid B, microgrid controller 101a transmits commands to a synchronous interface 108 through which the microgrid B connects to the microgrid A. The commands include information that indicates the synchronous interface 108 to wait for synchronization conditions between the microgrid A and the microgrid B. The synchronization conditions being voltage amplitude, phase, and frequency of two microgrids A and B have to be equal within a predetermined tolerance, when the two microgrids A and B are of single-phase. Further, the synchronous interface also checks for the sequences to coincide, when the two microgrids A and B are of three-phase.

The synchronous interfaces 108 and 118 are electrical interfaces that connect two electrical power systems, in one scenario microgrid A and microgrid B, and in the other scenario microgrid A or B and a public power grid 150.

An energy or power source (such as DERs 106a, 106b, DERs installed at houses 104a, and 104b) energizes the distribution network of a microgrid. Further, the distribution network may be configured to provide uninterrupted power supply to the customers 102a, 102b, 104a, 104b based on the power supply from the power sources 106a, 106b and power sources installed at houses 104a and 104b, and the charged storage batteries associated with the power sources. The DERs include a combination of photovoltaic generators and energy storage batteries that are controlled as unity. The DERs control an amount of active and reactive power exchanged with a grid in order to minimize a parameter known as area control error (ACE), which is calculated using the following expression (1):

$$ACE = [ \begin{matrix}F - {F}_{0} \\ V - {V}_{0}\end{matrix} ] + \frac{G}{N} \cdot ( {I}_{G}^{set} - {I}_{G} ) \qquad ( 1 )$$

where F, V are measured frequency and voltage at the connection point of DER with the grid, FO, VO are nominal frequency and voltage, I_{G}^{set} is the complex current set point calculated by a string controller of a DER as a function of its state of charge and of configuration values (such as operational parameters) received from a microgrid controller, and I_{G} is the measured complex current between a string and the distribution network, G is a 2×2 matrix of constant coefficients known as the governing matrix, and N is the number of inverters in a DER.

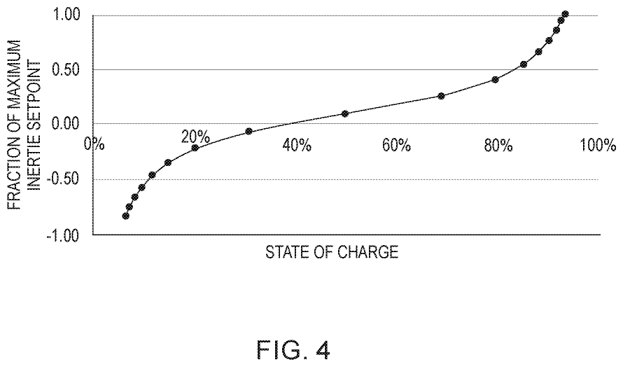

In one example, the active current component of I_{G}^{set} is calculated from a monotonically increasing function like the following expression (2):

$${I}_{a}^{set} ( p . u . ) = {δ}_{a} + \frac{tan ( {k}_{1} \cdot ( SOC - 0.5 ) )}{{k}_{2}} \qquad ( 2 )$$

where p.u. stands for per-unit, and represents a fraction of the rated current of the DER. In the case where δₐ is constant, the combined effect of expressions 1 and 2 is that when the average state of charge of the DERs in a microgrid is low, the frequency of the microgrid, which is the same at all the interconnections, will also be lower than the nominal value. FIG. 4 is a graph plotted between state of charge of a DER and a fraction of intertie set points.

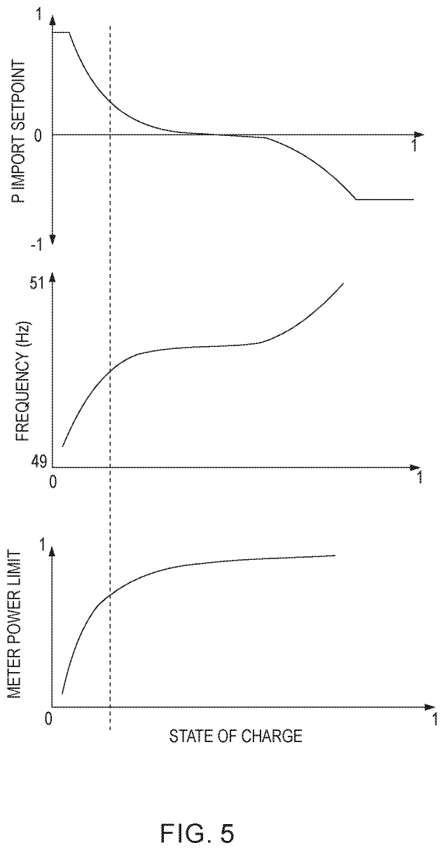

A dynamic meter 110 is a means by which customers access the distribution network. In addition to being conventional Advanced Metering Infrastructure (AMI) energy meter, the dynamic meters also disconnect a customer when certain conditions are met. The dynamic meters detect a fault in a building that it supplies and disconnects the customer until the building repairs the fault and manually resets the dynamic meter. The dynamic meter responds to scarcity conditions by disconnecting the customer if they are consuming more power than a dynamically adjusted value (such as power consumption limit). The dynamically adjusted value can be calculated from the measured frequency at the DER connection point, which according to expressions 1 and 2 correlate to the total remaining energy in all the batteries in the microgrid. For example, curve 3 shown in FIG. 5 is used to calculate the maximum active power limit. The horizontal axis represents average state of charge (SOC) of the microgrid, and the dotted line corresponds to an arbitrary operation state. The relatively low SOC results in dominant positive import settings for the DERs, which by virtue of expression 1 drives the frequency down. The dynamics meters respond to the frequency drop by restricting the power that users can take from the microgrid, thus slowing down the rate at which the batteries are drained. It has to be noted that different meters may follow different curves depending on the service conditions of each customer. The dynamic meter determines the power consumed by a consumer and reports the power consumption information to the microgrid controller.

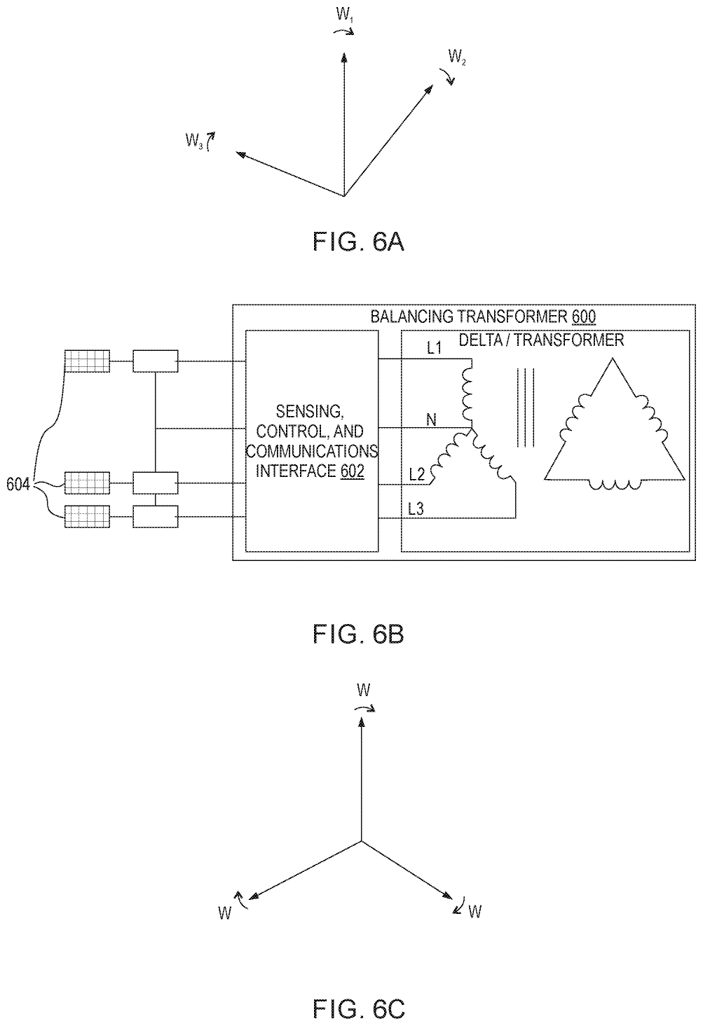

In general, the voltage waveforms in three-phase systems are spaced by 120 degrees, which results in zero current flowing through the neutral when the power drawn from the three phases is the same. Maintaining this phase separation is also important because many electrical machines rely on this to maintain constant torque. DERs are single-phase building blocks for decentralized energy systems (DES). If several DERs are connected between line and neutral on a three-phase feeder, the DES will behave like three independent single-phase networks and will not respect the angular spacing mentioned above. When plotted on a phase-magnitude diagram, each phasor will appear to be “spinning” about the origin at different angular speeds (w), and the angles between them will vary over time, which can be seen in FIG. 6A. The balancing transformer 115 solves this problem by coupling the distribution network to a three phase transformer whose windings are connected in a delta-wye configuration. FIG. 6B shows a simple view of this situation where the distribution network is not explicitly shown. The three DERs shown in FIG. 6B, as well as the balancing transformers themselves, can be connected anywhere in the distribution network.

The combined action of droop control in the DERs and secondary delta winding in the transformer shown in FIG. 6B, results in a stable operation that is close to balanced three-phase system implying that now there's a single frequency for all the distribution networks as shown in FIG. 6C, and that the phase angle differences are close to 120 degrees. There will be some exchange of active power and reactive power between phases, through the balancing transformer, depending on the balance of power generation and load on each phase, with two following important consequences:
1. The phase angle difference between phases, as well as the voltage amplitudes, will deviate from the ideal balanced three-phase system. This is relevant because it negatively impacts the performance of three-phase motors connected to the distribution network, and also because high voltages can cause transformer core saturation and adversely affect several types of loads.
2. Some amount of current will circulate through the windings of the transformer, which has to be kept below a safe limit to prevent thermal failures

The sensing, control, and communications interface 602 of the balancing transformer 600 protects the transformer, verifies that the phase voltage phasors are adequate for the connection of the transformer, and communicates its state to the microgrid controller, such that the microgrid controller changes the operation point of the DERs 604 (such as DERs 106a and 106b shown in FIG. 1) in the direction of reducing the imbalance between phases, therefore reducing the effect of the above-mentioned consequences.

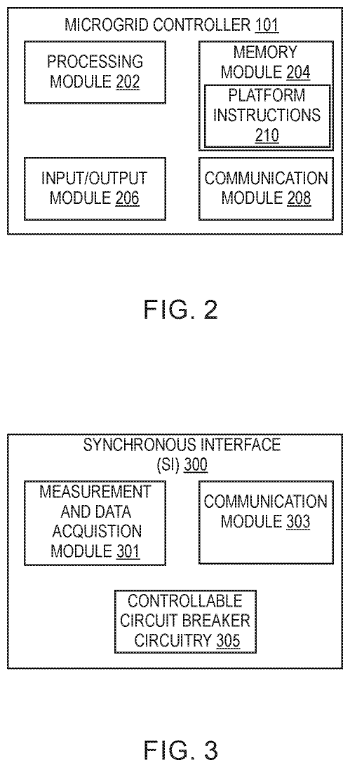

FIG. 2 is a block diagram of a microgrid controller 101 which is configured to control one or more components in the microgrid, in accordance with an embodiment of the invention.

The microgrid controller 101 is depicted to include a processing module 202, a memory module 204, an input/output (I/O) module 206, and a communication module 208. It is noted that although the microgrid controller 101 is depicted to include the processing module 202, the memory module 204, the I/O module 206, and the communication module 208, in some embodiments, the microgrid controller 101 may include more or fewer components than those depicted herein. The various components of the microgrid controller may be implemented using hardware, software, firmware or any combination thereof.

In one embodiment, the processing module 202 may be embodied as a multi-core processor, a single core processor, or a combination of one or more multi-core processors and one or more single core processors. For example, the processing module 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a graphic processing unit (GPU), a field programmable gate array (FPGA), a microcontroller unit (MCU), a hardware accelerator, a special-purpose computer chip, or the like. In one embodiment, the memory module 204 is capable of storing machine executable instructions, referred to herein as platform instructions 210. Further, the processing module 202 is capable of executing the platform instructions 210. In an embodiment, the processing module 202 may be configured to execute hard-coded functionality. In an embodiment, the processing module 202 is embodied as an executor of software instructions, wherein the instructions may specifically configure the processing module 202 to perform the algorithms and/or operations described herein when the instructions are executed.

The memory module 204 may be embodied as one or more non-volatile memory devices, one or more volatile memory devices and/or a combination of one or more volatile memory devices and non-volatile memory devices. For example, the memory module 204 may be embodied as semiconductor memories, such as flash memory, mask ROM, PROM (programmable ROM), EPROM (erasable PROM), RAM (random access memory), etc. and the like.

The communication module 208 is configured to facilitate communication between the microgrid controller 101 and one or more components in the environment 100 using a wired network, a wireless network, or a combination of wired and wireless networks. Some non-limiting examples of the wired networks may include the Ethernet, the Local Area Network (LAN), a fiber-optic network, and the like. Some non-limiting examples of the wireless networks may include the Wireless LAN (WLAN), cellular networks, Bluetooth or ZigBee networks, and the like.

In an example embodiment, the communication module 208 receives electrical measurements from a synchronous interface (SI). The electrical measurements are measured values related to voltage amplitude, frequency, and phase, etc., at the SI. The processing module 202 determines operational parameters for the one or more components in the microgrid based on the measurements received. The operational parameters include data related to the power to be injected into the microgrid from the DERs. In another example, the operational parameters may include instructions to control the dynamic meters. The processing module 202 determines the operational parameters to bias the operation of one or more DERs in the microgrid.

To determine the operation parameters, the processing module 202 is further configured to compare the measurements with a predetermined threshold. The determination of the operational parameters is further based on the comparison.

In an example embodiment, the communication module 208 is configured to receive information indicating that a failure has occurred in a neighboring grid connected to the microgrid, controlled by the microgrid controller, from the SI. For example, if the synchronous interface 118 shown in FIG. 1 identifies a failure of the public power grid 150, the SI transmits information indicative of the failure of the public power grid 150 to the microgrid controller 101. The processing module 202 is configured to transmit the operational parameters upon receiving the information indicating a failure of the neighboring grid.

In general, customer loads need that voltage and frequency of the power supply to be within certain limits. When there is failure of the neighboring grid connected to the microgrid, there will be disruptions in power supply of the microgrid if the microgrid is importing power from the neighboring grid. For example, the microgrid B and public power grid are neighboring grids that are connected to the microgrid A. When there is failure detected in any of the neighboring grids (e.g., public power grid 150 and microgrid B), then there will be instability in the power supply to the microgrid A. The synchronous interface disconnects the failed neighboring grid to which the synchronous interface was connected. For example, as shown in FIG. 1, synchronous interface 108 disconnects microgrid B if the microgrid B fails, and the synchronous interface 118 disconnects the public power grid 150 if the public power grid 150 fails.

If the microgrid was importing power from the neighboring grid when the failure has occurred, then there will be shortage in the power supply to the microgrid after disconnecting the failed neighboring grid. For example, power supply in the microgrid A falls short when the neighboring grid (e.g., public power grid 150 and microgrid B) is disconnected because of a failure. To stabilize the power supply, the processing module 202 determines the operational parameters for the one or more DERs connected to the microgrid. The operational parameters include values regarding the power to be injected into microgrid by the one or more DERs.

The processing module 202 is configured to detect whether the repair of the neighboring grid is completed. If power in the neighboring grid has been restored, the communication module 208 is configured to transmit control signals to the synchronous interface to connect the repaired neighboring grid to the microgrid, when the synchronization conditions are met. For example, the microgrid controller 101a transmits control signals to synchronous interface 108 to connect the microgrid B when the voltage, phase, and frequency of the microgrid A and microgrid B are equal within a predetermined tolerance.

In an example embodiment, the communication module 208 is configured to transmit parameters of the frequency versus limit function to one or more dynamic meters connected to one or more consumers (as shown in FIG. 1). The dynamic meters are the means by which the consumers access the distribution network. For example, as shown in FIG. 1, the consumers 104a and 102a access the distribution network by respective dynamic meter 110. The dynamic meters automatically disconnect consumers when consumption exceeds the limit as a function of the measured frequency. During power shortage, the dynamic meters disconnect the consumers when the power consumed by the consumers is more than a dynamically adjusted value. The dynamically adjusted value is determined from a measured frequency at a DER connection point to a microgrid (e.g., at the connection point of DER 106a for the microgrid A), which by virtue of expressions 1 and 2 will be correlated to the total remaining energy in all the batteries in the microgrid. The dynamically adjusted value is determined by a microgrid for each dynamic meter connected to each customer. The dynamically adjusted value for each customer's dynamic meter is different based on the service conditions of each customer.

FIG. 3 is a block diagram of a synchronous interface 300, in accordance with an example embodiment of the present disclosure. The synchronous interface 300 may be an example of the synchronous interfaces 108 and 118. The synchronous interface 300 may be configured to interconnect two active AC electric power systems (e.g., microgrids A and B, public power grid 150), in accordance with an embodiment of the invention.

The synchronous interface 300 includes a measurement and data acquisition module 301, a communication module 303, and a controllable circuit breaker circuitry 305.

In an example embodiment, the measurement and data acquisition module 301 is configured to determine the electrical measurements in the microgrid. The communication module 303 is configured to report the electrical measurements to the microgrid controller. The communication module 303 is configured to receive commands from the microgrid controller. The commands may indicate the controllable circuit breaker circuitry to open a circuit breaker. Further, the commands may include instructions to wait for the synchronization conditions to be met between the two AC electric power systems and close the circuit breaker when the synchronization conditions are met.

In a scenario, when there is failure detected in a neighboring grid connected to a microgrid, the communication module 303 is configured to send information indicative of a failure of the neighboring grid to a microgrid controller. For example, as shown in FIG. 1, the synchronous interface (SI) 108 is configured to report the failure of microgrid B to the microgrid controller 101a of microgrid A. For example, the SI 108 is configured to open the circuit breaker when there is a failure of the microgrid B. The SI 108 is configured to close the circuit breaker when the microgrid B is repaired after failure or when there is an initial setup of the connection of microgrid A with microgrid B. In one example, the circuit breaker can be of a single-phase or a three-phase.

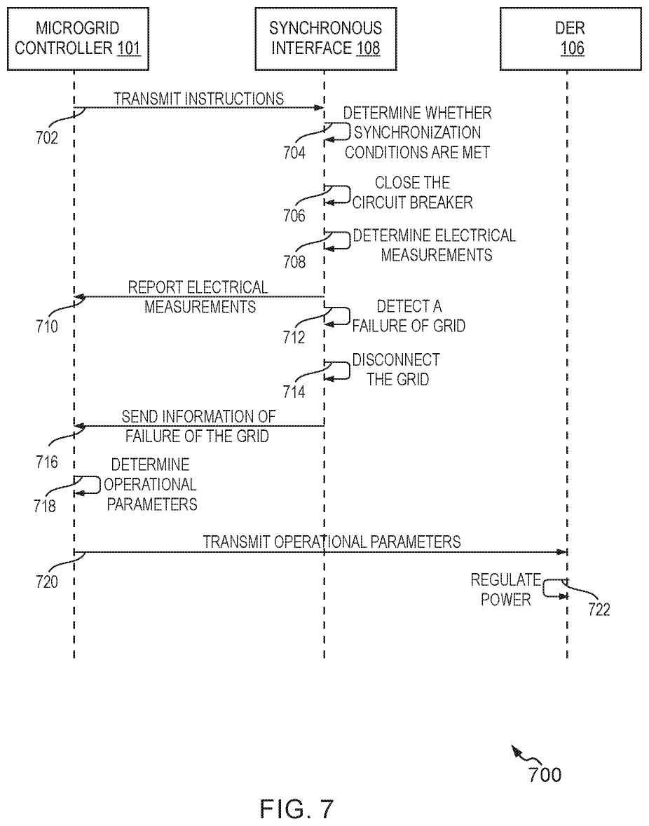

FIG. 7 illustrates a sequence flow diagram 700 depicting a process flow for controlling distributed energy systems in real-time, in accordance with an embodiment of the invention. The sequence flow diagram 700 starts at 702.

At 702, a microgrid controller 101 transmits instructions to synchronous interfaces 108 and 118 to set up a connection of a microgrid with other neighboring grids. The instructions include information indicative of the synchronous interfaces 108 and 118 to wait for the synchronization conditions between the microgrid and the other neighboring grid to be met. The instructions further indicate the synchronous interfaces 108 and 118 to close a circuit breaker of the synchronous interfaces 108 and 118 when the synchronization conditions are met. The synchronization conditions indicate that the voltage, frequency, and phase of the two grids should be equal within predefined tolerance when the two grids are of a single phase. Further, the synchronization conditions include the sequences of the phases to coincide when the two grids are of three-phase.

The synchronous interface is an electrical interface to connect two electric power systems (in this case two power grids). Any microgrid will have a nominal voltage and frequency for stable operation of the microgrid. The microgrid is energized by power generators connected to the microgrid, such as DERs, and other neighboring grids connected to the microgrid. When two grids are connected, there will be power flow between the grids.

At 704, the synchronous interfaces 108 and 118 determine whether the synchronization conditions are met between the two grids upon receiving instructions from the microgrid controller 101. For example, as shown in FIG. 1, the synchronous interface 108 determines whether the synchronization conditions are met between microgrid A and microgrid B upon receiving instructions from microgrid controller 101a.

At 706, the synchronous interfaces 108 and 118 close the circuit breaker upon determining that the synchronization conditions are met, thereby connecting the two grids with each other. By closing the circuit breaker, an electrical connection between the two grids is formed via the synchronous interface.

At 708, the synchronous interfaces 108 and 118 determine electrical measurements in the grids to which the synchronous interface is connected. The electrical measurements include values related to voltage, frequency, and phase in the grids. In one example, the electrical measurements may include information related to detection of a failure of the neighboring grid connected to the microgrid controlled by the microgrid controller 101.

At 710, the synchronous interfaces 108 and 118 report the electrical measurements to the microgrid controllers in the microgrids.

At 712, the synchronous interfaces 108 and 118 detect that there is a failure of the other neighboring grid connected to the microgrid controlled by the microgrid controller 101. For example, synchronous interface 108 detects that there is a failure in the microgrid B, shown in FIG. 1.

At 714, the synchronous interfaces 108 and 118 disconnect the failed neighboring grid connected to the microgrid controlled by the microgrid controller 101, in response to the detection of the failure.

At 716, the synchronous interfaces 108 and 118 transmit information indicating that a failure has occurred in the neighboring grid to the microgrid controller 101. In an example embodiment, the information can be sent along with electrical measurements.

At 718, the microgrid controller 101 determines operational parameters for one or more power generators (such as DERs and local power supplies) in the microgrid based on the received electrical measurements. In an example embodiment, the operation parameters include power injection setpoints for the elements in environment 100 as shown in FIG. 1, in order to the balance stage of charge, regulate voltage, reduce losses and maximize the security of supply in a microgrid. The operational parameters include instructions indicating the one or more power generators to regulate power injected into the microgrid to stabilize the microgrid because of the power imbalances caused by the failure of the neighboring grid. The power imbalances are caused by the failure of the neighboring grid if the microgrid was importing power from the neighboring grid at the time of failure. For example, in view of FIG. 1, there will be power distortions in microgrid A when microgrid A was importing power from microgrid B at the time of failure of microgrid B. The microgrid controller 101a determines operational parameters for the DERs and local power supply 104a of the microgrid A.

At 720, the microgrid controller 101 transmits the operational parameters to the one or more power generators or energy sources that energize the microgrid. The operational parameters bias the one or more energy resources to achieve control objectives in order to maximize power availability to end customers.

At 722, the DER 106a and the DER installed at the house 104a regulate power injected into microgrid based on the received operational parameters, such that voltage and frequency in the microgrid maintain at their nominal values and power supply in the microgrid being maintained without being affected by the failure of the neighboring grid.

In an example, the microgrid controller 101 transmits instructions to the synchronous interfaces 108 and 118 to reconnect the neighboring grid under the synchronization conditions when the neighboring grid is repaired.

In an example embodiment, the neighboring grid can be another microgrid (e.g., microgrid B in FIG. 1). In another example embodiment, the neighboring grid can be public power grid. In FIG. 1, the public power grid and microgrid B are the neighboring grids to microgrid A. In the case of the neighboring grid being another microgrid, the microgrid controller of a microgrid optionally transmits instructions to another microgrid controller of the neighboring grid to temporarily shut down the one or more energy sources in the neighboring grid until the neighboring grid is repaired.

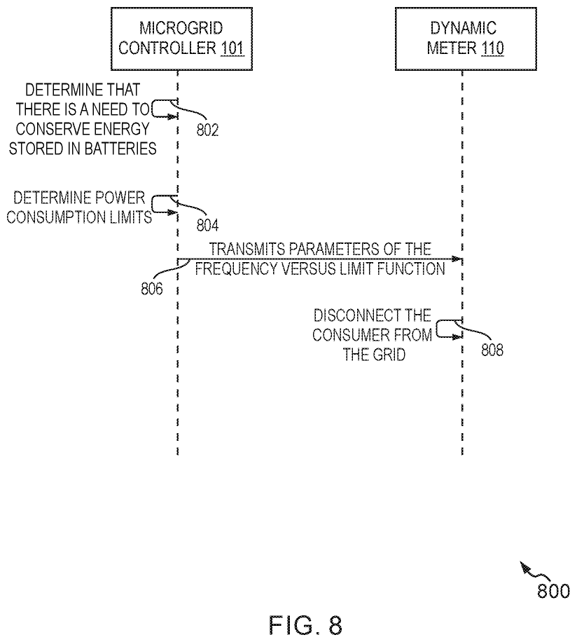

FIG. 8 illustrates a sequence flow diagram 800 depicting a process flow for managing energy scarcity, in accordance with an embodiment of the invention. The sequence process diagram 800 starts at 802.

Each customer in the microgrid will have a contract with microgrid provider to access electricity from the microgrid. Different contracts have different guaranteed levels of reliability of electricity access. For example, some contracts will have higher reliability which means that these contracts will be prioritized when there is energy scarcity in the microgrid. The prioritization of some of the contracts is implemented by the usage of dynamic meters. As discussed above, dynamic meters are AMI energy meters that provide access to the electricity of the microgrid for the customers. For example, in FIG. 1, dynamic meters 110 provide access to microgrids A and B for the customers 102a, 102b, 104a, and 104b.

Microgrids are prone to scarcity conditions, where there is either not enough energy or not enough power to meet the load. As a result, there are frequent blackouts that could have been avoided through a system that could elicit a response from the users of the network. The system includes microgrid controllers and dynamic meters that support non-invasive-demand side management by means of dynamically-adjusted consumption limits for the different contracts.

At 802, the microgrid controller 101 determines that there is a need to conserve energy stored in batteries in DERs and local power supply based on state of charge information provided by the DERs. For example, the microgrid controller 101a determines that there is less charge in the batteries of the DERs 106a and local power supply 104a, which leads to frequency in the microgrid being lower than a nominal frequency. This situation of less energy in the batteries will lead to dynamic instability in the microgrid.

At 804, the microgrid controller 101 determines power consumption limits for each of one or more customers in the microgrid based on the state of the charge of the batteries in the DERs and the contracts associated with respective customers. The contracts with higher priority will be given access to power in energy scarcity conditions, however, contracts with lesser priority will be disconnected from the microgrid when there is an energy scarcity condition in the microgrid.

At 806, the microgrid controller 101 transmits parameters of the frequency versus limit function to the dynamic meters.

At 808, the dynamic meter 110 automatically disconnects a customer when the power consumption by the consumer exceeds the limit as a function of the measured frequency.

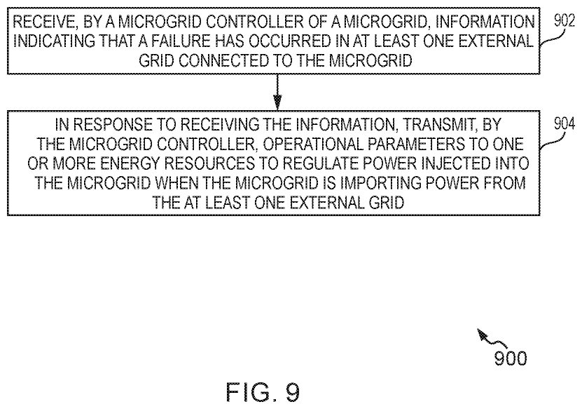

FIG. 9 represents a flow diagram depicting a method 900 for controlling a microgrid, in accordance with example embodiments of the present disclosure. The method 900 depicted in the flow diagram may be executed by a microgrid controller (e.g., the microgrid controller 101). Operations of the method 900 and combinations of operation in the flow diagram, may be implemented by, for example, hardware, firmware, a processor, circuitry and/or a different device associated with the execution of software that includes one or more computed program instructions. The method 900 starts at operation 902.

At operation 902, the microgrid controller receives information indicating that a failure has occurred in at least one external grid connected to the microgrid from one or more interfaces in the microgrid. The interfaces are synchronous interfaces that connect the microgrid with at least one external grid. The at least one external grid can be one of public power grid and one or more neighboring grids (e.g., microgrid B shown in FIG. 1).

At operation 904, the microgrid controller transmits operational parameters to one or more energy resources to regulate power injected into the microgrid when the microgrid is importing power from the at least one external grid. The operational parameters instruct the one or more energy resources (e.g., DERs shown in FIG. 1) to regulate the power injected into the microgrid to maintain the nominal frequency in the microgrid. Further, the operations 902 and 904, for automatically controlling the microgrid by the microgrid controller 101 are already described in detail in description pertaining to FIGS. 1, 2, and 7.

The disclosed methods with reference to FIGS. 7-9, or one or more operations of the sequence flow diagrams 700 and 800 and flow diagram 900 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components)) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), mobile communications, or other such communication means.

Various embodiments of the present disclosure facilitate sharing power and energy between energy resources deployed in distant locations without the need for high-speed communications. The embodiments herein allow to add distributed energy resources over time with minimal fixed costs and break apart a large interconnected system in the event of a major disruption, and automatically re-connect it after each segment has been repaired. The embodiments also describe a method to optimize the usage of energy resources in order to achieve high quality of service at minimum cost. The embodiments enable an efficient management of energy scarcity through non-intrusive demand-side management. Further, the embodiments facilitate decrease in the overall cost of electricity supply by the interconnection of distribution areas and improve voltage regulation and reduce losses across a distribution area. Furthermore, the embodiments enable a rapid recovery of electricity service after major disturbances such as hurricanes, earthquakes and fires.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A method, comprising:
receiving, by a microgrid controller of a microgrid, information indicating that a failure has occurred in at least one external grid connected to the microgrid from one or more interfaces in the microgrid;
receiving, by the microgrid controller, electrical measurements from the one or more interfaces that connect the microgrid with the at least one external grid, wherein the electrical measurements include voltage, phase, and frequency at an interface of the one or more interfaces;
determining, by the microgrid controller, operational parameters for operation of the one or more energy resources in the microgrid based on the electrical measurements; and
in response to determining the operational parameters, transmitting, by the microgrid controller, operational parameters to one or more energy resources to regulate power injected into the microgrid based on the operational parameters, when the microgrid is importing the power from the at least one external grid.

2. The method as claimed in claim 1, further comprising:
determining that there is a need to conserve charge stored in batteries of the one or more energy resources based on state of charge information received from the one or more energy resources; and
determining power consumption limits for each of one or more customers connected to the microgrid based on the state of charge and contracts associated with respective customers, wherein a contract includes service conditions for a customer.

3-4. (canceled)

5. The method as claimed in claim 1, wherein the at least one external grid comprises at least one of a public grid and one or more neighboring grids.

6. The method as claimed in claim 1, further comprising transmitting instructions to the one or more interfaces to setup a connection of the microgrid with at least one external grid.

7. The method as claimed in claim 6, wherein the instructions include information indicative to the one or more interfaces to wait for synchronization conditions between the microgrid and the at least one external grid to be met, and wherein the instructions further indicate the one or more interfaces to close a circuit breaker of the one or more interfaces when the synchronization conditions are met.

8. A microgrid controller, comprising:
a processor;
a communication interface; and
a memory for storing instructions which, when executed by the processor, cause the microgrid controller at least in part, to:
receive information indicating that a failure has occurred in at least one external grid connected to a microgrid from one or more interfaces in the microgrid, wherein the microgrid is controlled by the microgrid controller;
receive electrical measurements from the one or more interfaces that connect the microgrid with the at least one external grid, wherein the electrical measurements include voltage, phase, and frequency at an interface of the one or more interfaces;
determine operational parameters for operation of the one or more energy resources in the microgrid based on the electrical measurements; and
in response to the determination of the operational parameters, transmit the operational parameters to one or more energy resources to regulate power injected into the microgrid based on the operational parameters, when the microgrid is importing the power from the at least one external grid.

9. The microgrid controller as claimed in claim 8, wherein microgrid controller is further caused, at least in part, to:
determine that there is a need to conserve charge stored in batteries of the one or more energy resources based on state of change information received from the one or more energy resources; and
determine power consumption limits for each of one or more customers connected to the microgrid based on the state of charge and contracts associated with respective customers, wherein a contract includes service conditions for a customer.

10-11. (canceled)

12. The microgrid controller as claimed in claim 8, wherein the at least one external grid comprises at least one of a public grid and one or more neighboring grids.

13. The microgrid controller as claimed in claim 8, wherein microgrid controller is further caused, at least in part, to transmit instructions to the one or more interfaces to setup a connection of the microgrid with at least one external grid.

14. The microgrid controller as claimed in claim 8, wherein the instructions include information indicative to the one or more interfaces to wait for synchronization conditions between the microgrid and the at least one external grid to be met, and wherein the instructions further indicate the one or more interfaces to close a circuit breaker of the one or more interfaces when the synchronization conditions are met.

15. A system, comprising:
at least one microgrid controller configured to:
receive information indicating that a failure has occurred in at least one external grid connected to a microgrid from one or more interfaces in the microgrid, wherein the microgrid is controlled by the at least one microgrid controller;
receive electrical measurements from the one or more interfaces that connect the microgrid with the at least one external grid, wherein the electrical measurements include voltage, phase, and frequency at an interface of the one or more interfaces;
determine operational parameters for operation of the one or more energy resources in the microgrid based on the electrical measurements; and
in response to the determination of the operational parameters, transmit operational parameters to one or more energy resources to regulate power injected into the microgrid based on the operational parameters, when the microgrid is importing the power from the at least one external grid.

16. The system as claimed in claim 15, wherein the interface is configured to:
transmit electrical measurements to the at least one microgrid controller;
disconnect the at least one external grid upon detection of failure of the at least one external grid; and
reconnect the at least one external grid when synchronization conditions are met between the microgrid and the at least one external grid.

17. The system as claimed in claim 15, further comprising at least one energy meter configured to disconnect a customer when the power consumed by the customer is greater than a predetermined value.

18. The system as claimed in claim 15, further comprising at least one balancing transformer, wherein the at least one balancing transformer comprises a sensing, control, and communications interface configured to transmit state information of the at least one balancing transformer to the at least one microgrid controller.

19. The system as claimed in claim 15, further comprising the one or more energy resources configured to energize a distribution network of the microgrid, and wherein the one or more energy resources are configured to regulate the power injected into the microgrid based on the received operational parameters.

20. The system as claimed in claim 17, wherein the at least one energy meter is configured to disconnect the customer when the consumption exceeds the limit as a function of the electrical measurements at the interface.
